(19) United States
(12) Patent Application Publication
(10) Pub. No.: US 2012/0267055 A1
(43) Pub. Date: Oct. 25, 2012

(54) METHOD AND DEVICE FOR MOUNTING A PNEUMATIC TIRE

(75) Inventors: Martin ROGALLA, Darmstadt (DE); Georg LIPPONER, Zwingenberg (DE); Andreas PEINELT, Pfungstadt (DE); Matthias LEMSER, Weiterstadt (DE); Kevin WEISSBACH, Gelenau (DE)

(73) Assignee: Schenck RoTec GmbH, Darmstadt (DE)

(21) Appl. No.: 13/409,433

(22) Filed: Mar. 1, 2012

(30) Foreign Application Priority Data
Apr. 19, 2011 (DE) 10 2011 002 180.9
Dec. 7, 2011 (EP) 11192490.8

(51) Int. Cl. B60C 25/138; B23P 11/00

(52) U.S. Cl. 157/1.24; 29/894.31

(57) ABSTRACT

To mount a pneumatic tire (R) on a drop base rim (F), the pneumatic tire (R) is gripped by a gripper (2), which is arranged on a handling device (1), on the tread, and the first tire bead thereof is slipped over a flange of the rim (F) by controlled movement of the gripper (2). Subsequently, the gripper (2) is released from the pneumatic tire (R), and the tire (R) is moved into an initial position for mounting the second tire bead by adjustment members (33, 34). Mounting tools (27, 28, 29) arranged on the gripper (2) are guided along on the rim (F) by rotating the gripper (2) about the axis of the rim (F), resulting in the second tire bead being slipped over the rim (F).

### CROSS REFERENCE TO RELATED APPLICATIONS

Applicants claim priority under 35 U.S.C. §119 of German Patent Application No. 10 2011 002 180.9 filed Apr. 19, 2011 and of European Patent Application No, 11192490.8 filed Dec. 7, 2011.

### FIELD OF THE INVENTION

The invention relates to a method for mounting a pneumatic tire on a drop base rim of a vehicle wheel, in which the pneumatic tire is gripped in a preparation position by a gripper, which is arranged on a handling device, on the tread, and guided by the handling device to the rim, which is held in a fixing device, and the first tire bead thereof, which faces the rim, is slipped over a flange of the rim by controlled movement of the gripper, which holds the pneumatic tire. The invention further relates to a device for carrying out the method.

### BACKGROUND OF THE INVENTION

A method of the specified type for automatically mounting pneumatic tires on drop base rims is known from EP 1 738 937 A2. In this case, the pneumatic tire is handled and mounted using a gripper, which is attached to a pivot arm or a hand of a handling robot and is configured to be able to grip and hold the pneumatic tires on the outer circumference in the region of the tread and to be able to abut against a side wall of the pneumatic tire. According to the known method, by controlled movement of the gripper, a tire can be mounted by only one tire bead, or if appropriate by both tire beads. If it is difficult to mount both tire beads by this method, the first tire bead can be mounted using the handling device and the gripper, and the second tire bead can be mounted in a conventional manner, in a downstream mounting device having mounting tools which are guided along on the rim flange.

In a method known from EP 1 916 124 A1 for machine-mounting vehicle tires, the rim or the disc wheel is held in place in a horizontal position by a fixing device. The pneumatic tire is laid obliquely on the rim and slid onto the rim until a lower portion of the lower tire bead is pressed into the drop base of the rim, whilst the upper portion thereof projects over the upper rim flange. Subsequently, mounting tools are lowered onto the tire and the rim from above. The tire bead is subsequently pulled continuously over the upper rim flange by rotating the mounting tools about the axis of rotation of the rim. The process is repeated to mount the second upper tire bead.

EP 1 054 783 B1 discloses a method and a device in which the rim is initially fixed in place in a tire mounting station, and subsequently, the tire is laid on the rim in a predetermined eccentric position on the rim and held by a clamp. A tool for mounting the tire bead, which tool is arranged on an articulated arm of a robot, is brought into engagement with the tire and guided around the rim on a programmed path so as to slip the first bead over the edge of the rim. Once the tool has passed through approximately 360° relative to the rim, it is brought into engagement with the second bead of the tire and moved along a second programmed path, carrying out a second movement around the entire circumference of the rim so as to mount the second bead on the rim.

Further, DE 10 2006 0571 71 A1 discloses a device for mounting a pneumatic tire on a rim of a vehicle wheel with a handling robot, which comprises a robot hand, movable about a plurality of axes and having a flange which can be driven in rotation, and a gripper, which is attached to the robot hand and has a base body and gripper arms, which are movable radially with respect to the central axis of the gripper and are coupled to a synchronisation device which synchronises the radial movement of the gripper arms. The synchronisation device comprises a disc, which is mounted rotatably on the base body and can be driven in rotation by a motor, and coupling members, which are fastened to the disc and the gripper arms by hinges in such a way as to bring about synchronous radial movement of the gripper arms when the disc rotates.

### SUMMARY OF THE INVENTION

The object of the invention is to provide a method for mounting tires, of the type stated at the outset, which can be carried out inexpensively and is adapted for a number of pneumatic tire variants. A further aim is to create a device which makes it possible to mount the tires completely in one fixing of the rim in a short time.

In the method according to the invention, the pneumatic tire is gripped in a preparation position by a gripper, which is arranged on a handling device, on the tread, and brought up by the handling device to the rim, which is held in a fixing device, and the first tire bead thereof, which faces the rim, is slipped over a flange of the rim by controlled movement of the gripper, which holds the pneumatic tire. Subsequently, the gripper is released from the pneumatic tire, and the tire is moved into an adapted initial position for mounting the second tire bead by means of adjustment members which are arranged on the fixing device. Subsequently, mounting tools arranged on the gripper are brought into a working position on the rim, which is held in the fixing device, by moving the gripper and are guided along on the rim flange by rotating the gripper about the axis of the rim in such a way that the second tire bead being slipped over the flange of the rim by the mounting tools.

The method according to the invention has the advantage that fully automatic tire mounting on machines is made possible at relatively low expense. The entire mounting process, comprising introducing the tire to the mounting station, soaping the tire beads, attaching the two tire beads and removing the mounted wheel, can be carried out in one pass using a single mounting station. The method further has the advantage that it is adapted for various types of wheel and tire and sizes of wheel and tire, and that various types of tire and wheel can be processed in a varying sequence without expensive retooling steps. Further, short times can be achieved for carrying out a mounting cycle.

According to a further aspect of the invention, an advantageous device for carrying out the method comprises a handling device having an articulated arm, which can move in three directions and which comprises at the free end thereof a gripper having at least two gripper arms which can move radially relative to the central axis of the gripper, for gripping and holding pneumatic tires, and a mounting station, which is arranged in the working region of the handling device and comprises gripping means for releasably holding a rim and adjustment members for positioning the pneumatic tire relative to the rim, it being possible to rotate the gripper on the articulated arm about the central axis and about at least one further axis and to lock said arm in any desired angular positions of rotation using actuating drives, tools for attaching a tire bead to a rim being arranged on the gripper, and the gripper being able to move on a circular path by means of the actuating drive and optionally the articulated arm, in such a way that the tools can be guided along on the flange of the rim.

The device according to the invention is distinguished by low manufacturing costs, since additional conveying devices for introducing the pneumatic tires to the mounting station and removing the mounted wheels are not necessary. Further, only one mounting station, having gripping means for holding the rim and adjustment members for positioning the pneumatic tire in the mounting station, is required.

With the device according to the invention, pneumatic tires can be mounted on a rim by the method according to the invention, but can also be mounted completely conventionally in that the two tire beads are mounted by the tools arranged on the gripper.

According to a further proposal of the invention, the tools for attaching a tire bead may be arranged on a gripper arm and the gripper arms may be movable into a closed position in which the free ends of the gripper arms abut against one another. This configuration has the advantage that the tools do not obstruct gripping and mounting a tire. The closed position in which the gripper arms abut against one another provides a particularly rigid connection between the gripper arm comprising the tools and the handling device. This provides that the tools can be moved along on the rim edge at a slight distance, without touching it, by means of the gripper.

So as further to improve the mutual abutment of the gripper arms in the closed position, it may be provided that holding means are arranged at the free ends of the gripper arms, and engage with one another, preventing relative movement of the gripper arms, when the gripper arms are in the closed position.

It is further advantageous for each gripper finger to comprise a holding plate, orientated parallel to the central axis of the gripper and comprising edges which extend parallel to the central axis and have projections and recesses, and for the edges of the holding plates to abut against one another when the gripper arms are in the closed position, the projections and recesses engaging with one another and preventing relative movement of the holding plates in at least one direction.

According to a further proposal of the invention, the gripper comprises a central base body on which the gripper arms are mounted, the gripper arms being coupled by a synchronisation device which synchronises the radial movement thereof, each gripper arm having two parallel connecting rods, one end of each connecting rod being connected by hinges to the base body and the other end thereof being rotatably connected to a holding plate in such a way that the connecting rods form a parallel guide for the holding plate.

An alternative embodiment of the device according to the invention may involve the gripper arms and the tools for attaching a tire bead being arranged on a central base body of the gripper, the tools being connected to the base body in a bending-resistant manner, and the gripper arms being able to move into a spread position in which they are positioned outside the working region of the tools. In this configuration of the invention, the gripper arms are unloaded when a tire bead is attached by the tools. Due to the reduced load on the gripper arms they can be realized in a lighter construction. Since the gripper arms have to be spread apart so as not to obstruct the attachment process, a larger free space is required in the vicinity of the mounting station in this embodiment.

The handling device according to the invention comprises a programmable control device for controlling the opening and closing of the gripper and the gripper movements. This makes it possible to adapt the mounting process individually to the respective size and shape of the rim and the tire in a simple manner. Further, load sensors for detecting the loads occurring during tire mounting can be arranged on the handling device. The signals of the load sensors can be monitored by a monitoring device, which is connected to the control device, so as to be able to vary the control of the handling device when predetermined load values are exceeded.

### BRIEF DESCRIPTION OF THE DRAWINGS

The invention will be described in greater detail in the following by way of embodiments shown in the drawings, in which:

FIG. 1 shows a handling robot comprising a device according to the invention,

FIG. 2 shows the gripper of the device according to FIG. 1,

FIG. 3 shows the introduction of a pneumatic tire to a rim held by a fixing device,

FIG. 4 shows the start of the attachment of the first tire bead by means of the gripper,

FIG. 5 shows the position of the gripper after the first tire bead has been attached,

FIG. 6 shows the closed position of the gripper for attaching the second tire bead,

FIG. 7 shows the initial position of the tools arranged on the gripper for attaching the second tire bead,

FIG. 8 shows a position of the gripper during the attachment of the second tire bead,

FIG. 9 shows a second embodiment of a device according to the invention during the attachment of the second tire bead,

FIG. 10 shows a third embodiment of a device according to the invention, and

FIG. 11 shows the embodiment according to FIG. 10 in a gripper position for attaching the second tire bead.

### DETAILED DESCRIPTION OF THE DRAWINGS

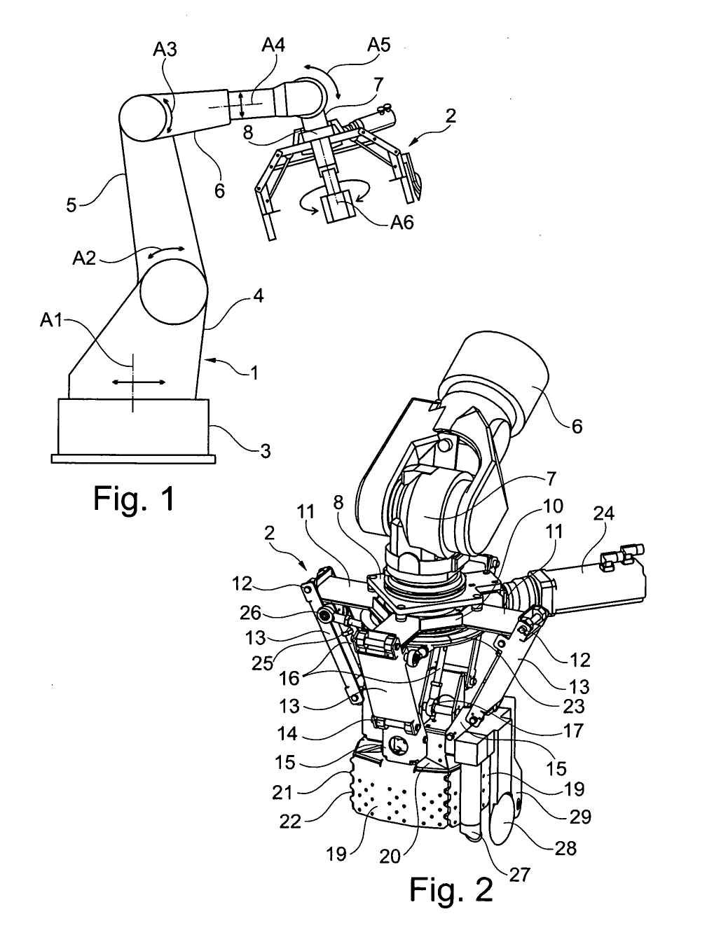

FIG. 1 shows a handling robot 1 comprising a gripper 2, which can be moved by said robot and is set up for gripping and holding pneumatic tires. The handling robot 1 consists of a fixed base frame 3, on which a carousel 4 having a rocker 5, an arm 6 and a robot hand 7 rotates about a vertical axis A1. The rocker 5 can be rotated on the carousel 4 about a horizontal axis A2 and the arm 6 can be rotated on the rocker 5 about a horizontal axis A3. The arm 6 consists of two parts which can be rotated relative to one another about an axis A4 extending in the longitudinal direction of the arm 6. The robot hand 7 is connected to the arm 6 so as to be rotatable about an axis A5 extending transverse to the longitudinal axis of the arm 6. The robot hand 7 comprises, at the free end thereof, a flange 8 which can be rotated about an axis A6. All of the axes A1 to A6 of the handling robot 1 can be actuated by controlled servo motors. Brakes and resolvers for measuring the angle of rotation are integrated into the servo motors. The robot is equipped with a control system which can be programmed as desired and can move each of the aforementioned axes individually into any desired angle of rotation and fix it there. By means of the servo motor arranged on the robot hand 7, the gripper 2 can be rotated and positioned precisely at an angle of rotation relative to the robot hand 7.

The gripper 2 is shown more clearly in FIG. 2, and has a base body 10, which is fastened to the flange 8 and comprises four arms 11, which are arranged in a cross shape and extend radially outwards. Gripper arms 13 are pivotably mounted on the radially outer ends of the arms 11 via hinges 12. Gripper fingers 15 are pivotably mounted on the free ends of the gripper arms 13 via hinges 14. The axes of the hinges 12 and 14 of each gripper arm 13 are parallel and orientated tangential to the central axis of the gripper 2. On the side of the gripper arms 13 facing the centre of the gripper, connecting rods 16 are arranged parallel to said arms with spacing, and one end of each connecting rod is connected to a gripper finger 15 by a hinge 17 and the other end thereof is connected to an arm 11 by a hinge. Together with the gripper arms 13, the connecting rods 16 form a pivotable parallel guide, which causes the gripper fingers 15 to maintain the predetermined orientation thereof relative to the central axis of the gripper 2 when the gripper 2 opens and closes.

The gripper fingers 15 each have a holding plate 19, which is orientated substantially parallel to the central axis of the gripper 2 and is intended to be placed on the tread of the pneumatic tire. A plate 20, by which the gripper can abut against a side wall of a pneumatic tire, extends radially inwards from the holding plate 19 and perpendicular thereto. Each holding plate 19 is provided, on the two end edges parallel to the central axis of the gripper 2, with a plurality of tooth-like projections 21 and recesses 22. The projections 21 and recesses 22 of an end edge are axially offset with respect to the projections 21 and recesses 22 of the other end edge, in such a way that in the maximum closed position of the gripper 2, as shown in FIG. 2, in which the end edges of the holding plates 19 lie against one another, the projections 21 and recesses 22 of adjacent holding plates 19 engage with one another without play and connect the holding plates 19 in a positive fit. In this way, in the maximum closed position of the gripper 2, the gripper arms 13 and the gripper fingers 15 form, together with the base body 10, a rigid, lattice-like body, which can transmit the forces required for attaching a tire bead from the robot hand 7 to mounting tools without significant deformation.

To open and close the gripper 2, the gripper arms 13 can be moved synchronously away from or towards one another. A rotatable disc 23 is provided for producing this synchronous movement, and is mounted on the base body 10 so as to be rotatable about the central axis of the gripper 2. A servo motor 24 is arranged on the base body 10, and is drivingly connected to the disc 23 via an angular gear so as to rotate the disc 23. The disc 23 is connected to each gripper arm 13 by a respective rod-shaped coupling member 25. The coupling members 25 are of equal length, and carry on the ends thereof hinges 26, which have at least two degrees of freedom and via which they are fastened to the disc 23 and to a gripper arm 13. The hinges 26 are arranged on the disc 23 with an angular spacing of 90° and at the same distance from the axis of rotation of the disc 23, When the disc 23 is rotated by the servo motor 24, the hinges 26, which are connected to the gripper arms 13, of the coupling members 25 move in a radial direction, causing the gripper arms 13 mounted on the arms 11 to pivot in the corresponding direction.

Three mounting tools 27, 28, 29 are fastened to a gripper finger 15. The mounting tools 27, 28, 29 are located on the outside of the holding plate 19 and the working ends thereof project past the edge of the holding plate 19 remote from the gripper arm 13. The working end of the mounting tool 27 forms a bead deflector, which presses the tire bead in the radial direction from the rim flange. It is followed during the attachment process by a pressure roller, which presses the tire bead into the rim base, of the mounting tool 28. The mounting tool 29 has on the working end a follow-up roller, which is of a smaller diameter than the pressure roller of the mounting tool 28. The arrangement of the mounting tools 27, 28, 29 on the outside of the holding plate 19 means that they do not obstruct the gripping operation of the gripper. In the maximum closed position of the gripper 2, as shown in FIG. 2, the mounting tools can be used to attach a tire bead in that the closed gripper is moved, by the handling robot 1, in such a way that the mounting tools 27, 28, 29 are guided along on the rim edge on a circular path concentric with the rim.

In the following, the method for mounting a pneumatic tire on a drop base rim is explained in greater detail by way of the disclosed device.

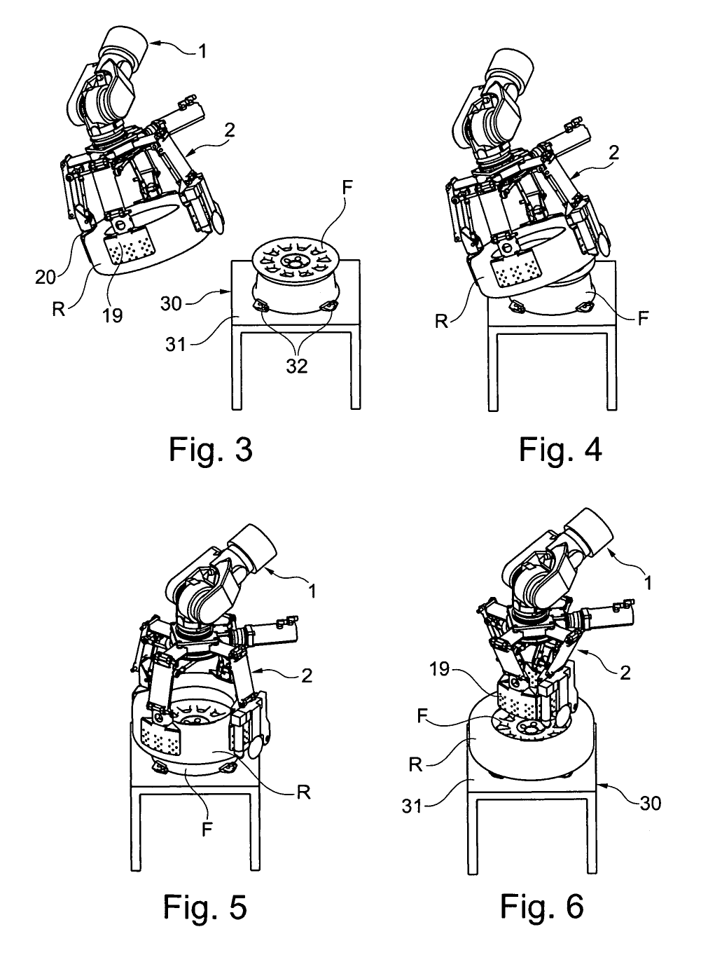

As is shown in FIG. 3, to mount a tire R on a rim F, the rim F is fixed in a fixing device 30. In this context, an edge of the rim is laid on a platform 31 of the fixing device 30, and the rim is subsequently fixed in place at the contacting rim edge by synchronously radially movable fixing jaws 32. The tire R is fetched by an introduction means (not shown) arranged in the working region of the handling robot 1, in that the gripper 2 engages the tire R on the tread with the holding plates 19, in such a way that the plates 20 lie against the side wall of the tire R. The handling robot initially conveys the tire R to a wetting station, in which the tire beads are wetted with a lubricant. Subsequently, the tire R is guided onto the rim F in an oblique position at an inclination to the horizontal, as shown in FIG. 3, and drawn over the rim, as shown in FIG. 4, in such a way that on one side the upper rim edge penetrates into the opening of the first tire bead facing the rim F, and the tire bead on this side passes into the rim base.

The tire R is subsequently moved into a horizontal position by the gripper 2 while continuing to approach the rim F, the first tire bead being slipped completely over the rim flange. The resulting mounting state is shown in FIG. 5.

To mount the second, upper tire bead, the gripper 2 is opened, and removed from the tire R by lifting. The tire R thus comes to lie on the lower rim flange and the platform 31. Once the gripper 2 is at a sufficient distance above the tire R and the rim F, it is moved into the maximum closed position, in which the holding plates 19 lie against one another and are positively interconnected by the mutually engaging projections 21 and recesses 22. This initial position for mounting the second tire bead is shown in FIG. 6.

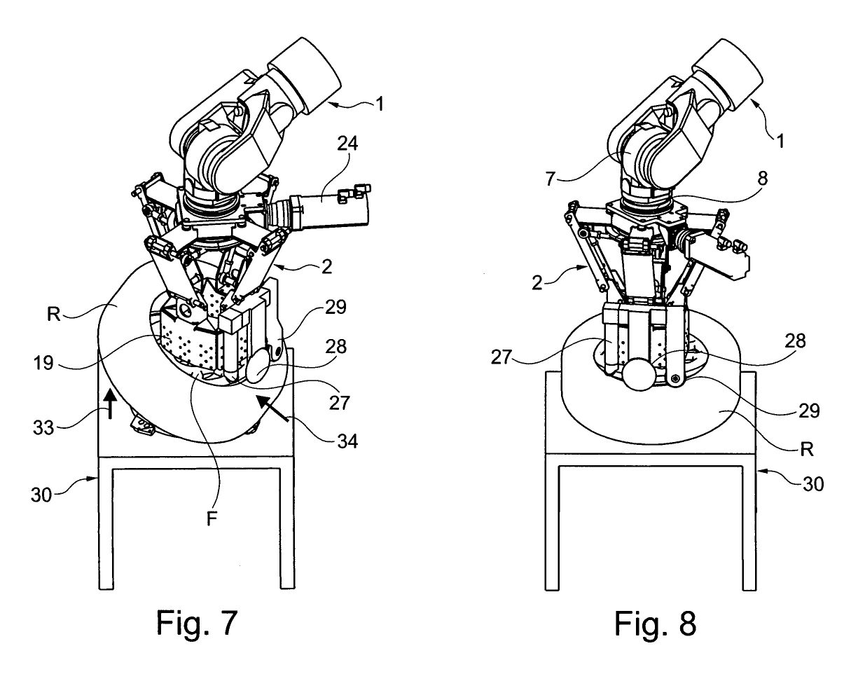

To place the mounting tools 27, 28, 29, it is first necessary to lift the tire R on one side by means of a tire lift, arranged on the fixing device 30 and illustrated by the arrow 33, and to bring it into an oblique position with respect to the rim F. Further, on the side which is not lifted, the tire R is pressed against the rim by a tire slide, movable radially with respect to the rim and illustrated by the arrow 34, in such a way that the second tire bead engages in the drop base of the rim F. The maximally closed gripper 2 is subsequently lowered towards the rim F and positioned close to the free edge of the rim F using the mounting tools 27, 28, 29, but without touching the rim edge. This mounting situation is shown in FIG. 7. In this context, the holding plates 19 form a ring, which is at a sufficient distance above the rim F and has a sufficiently small diameter so as not to touch the tire bead.

After the mounting tools 27, 28, 29 are positioned on the edge of the rim F, the tire lift 33 is lowered back into the initial position, so as not to obstruct the attachment of the second tire bead.

The gripper 2 is subsequently moved onwards with the mounting tool 27 leading on a circular path concentric with the rim F, in such a way that the tangential orientation of the mounting tools 27, 28, 29 with respect to the rim axis is left unchanged. In general, the radius of this circular path will be greater than the distance of the mounting tools 27, 28, 29 from the central axis of the gripper 2. The movement of the mounting tools 27, 28, 29 along the circular path therefore requires rotation of the gripper 2 using the flange 8 of the robot hand 7, and also, synchronously with this rotation, a movement of the axis of the robot flange 8 about the axis of the rim F. The two movements can be precisely controlled by the robot control system by way of the specified data for the size and position of the rim and for the distance of the tools from the axis of rotation of the gripper 2.

FIG. 8 shows the position of the mounting tools 27, 28, 29 after a rotation of the gripper 2 through approximately 90°. The attachment of the second tire bead is only complete when the mounting tools 27, 28, 29 have returned to the initial position thereof after moving through a complete circle. The gripper 2 is subsequently raised, opened and lowered again, so as to grip the tire R again. At the same time, the fixing device 30 is opened, in such a way that the handling device can convey the mounted wheel, consisting of the rim and tire, onwards to a subsequent processing station, for example a tire filling station.

The disclosed tire bead mounting, using the mounting tools arranged on the gripper, can also be applied for mounting the first tire bead, if the shape of the tire does not allow the first tire bead to be attached by targeted movements of the tire held by the gripper. In a case of this type, first the first tire bead and subsequently the second tire bead of the tire deposited on the rim can be mounted using the mounting tools.

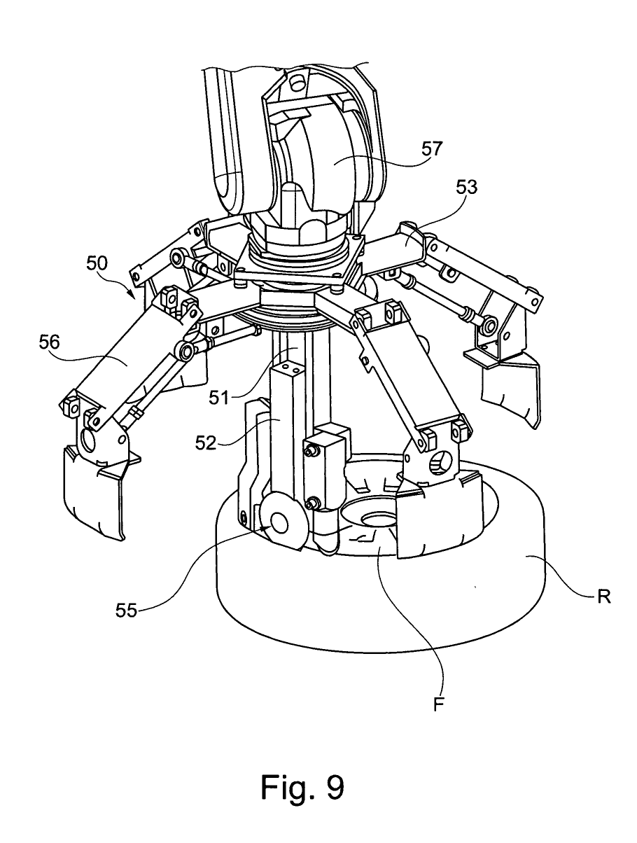

FIG. 9 shows a variant embodiment of a gripper 50, which corresponds to the gripper 2 apart from the arrangement of the mounting tools and the shape of the holding plates. The gripper 50 comprises a central column 51, which extends in the direction of the central axis of said gripper and to which a tool slide 52 is mounted so as to be displaceable in the longitudinal direction. Using an actuating drive, the tool slide 52 can be moved between a rest position close to the base body 53 and a mounting position further from the base body 53. Mounting tools 55 comprising a bead deflector, a pressure roller and a follow-up roller are arranged on the tool slide 52. The gripper 50 is arranged on a robot hand 57 of a handling robot (not shown) which is substantially identical to the handling robot 1. All gripper operations, such as conveying tires and mounted wheels and attaching the first tire bead, can be carried out using the gripper 50 when the tool slide 52 is in the rest position close to the base body 53. If the mounting tools 55 are to be used to attach a tire bead, the tool slide 52 is moved into the mounting position shown in the drawing and the gripper arms 56 are spread apart. In this way, the gripper fingers are far enough away from the mounting tools 55 that a tire can be attached using the mounting tools 55 by simultaneous rotation and movement of the gripper axis along a circular path.

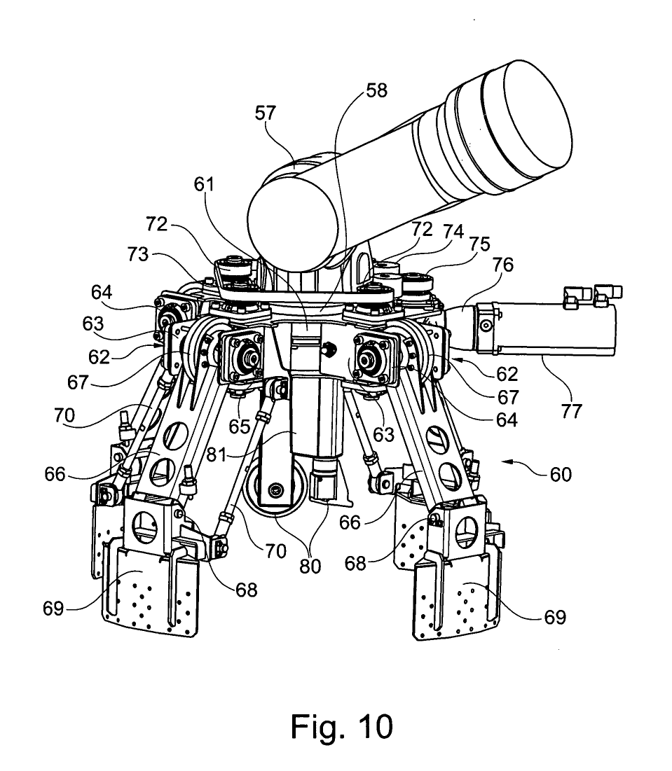

A further embodiment shown in FIG. 10 comprises a gripper 60 having a base body 61 which is fastened to the flange 58, which can be driven in rotation, of a robot hand 57, which can be moved in three spatial directions. The base body 61 has four arms 62, which are arranged in a cross shape, extend radially outwards with respect to the central axis of the gripper 60, which axis is coincident with the axis of rotation of the flange 58, and are each formed by two parallel arm plates 63 arranged at a distance from one another. Bearing housings 64 are arranged at the free ends of the arm plates 63, and an axle 65 is rotatably mounted in every two bearing housings 64 associated with the same arm 62 and traverses the intermediate space between the arm plates 63. Each axle 65 provides rotatable mounting of a pivotable gripper arm 66. For this purpose, a toothed wheel 67, to which a forked end of a gripper arm 66 is fastened by screws, is arranged on each axle 65 in the centre between the arm plates 63. Gripper fingers 69 are pivotably mounted on the free ends of the gripper arms 66 via hinges 68, the common axis of rotation of the hinges 68 of each gripper arm 66 being parallel to the axle 65 which mounts the gripper arm 66. The gripper fingers 69 are moreover articulated to the arms 62 by connecting rods 70, which are arranged parallel to the gripper arms 66 and are of a length corresponding to the gripper arms 66. This results in parallel guidance of the gripper fingers 69, which causes the gripper fingers 69 to maintain the orientation thereof parallel to the central axis of the gripper 60 when the gripper arms 66 are pivoted.

The gripper arms 66 are driven via the toothed wheels 67. Each toothed wheel 67 is engaged with a worm wheel, which is rotatably mounted and supported on the base body 61 and can be driven by a cylindrical gear 72 which is rotationally engaged with the worm wheel. The four identical cylindrical gears 72, which are associated with the four gripper arms 66, are driven via a toothed belt 73, which is guided about a drive wheel 75 and deflected around the cylindrical gears 72 by return rollers 74. The toothed belt 73 synchronises the rotational movement of the cylindrical wheels 72 and that of the worm wheels driven thereby, and thus provides synchronous movement of the gripper arms 66. The drive wheel 75 is arranged on an angular gear 76 fastened between two arms 62 on the base body 61, and is driven by a motor 77 connected to the angular gear 76. The gripper 60 can thus be opened and closed by controlling the motor 77.

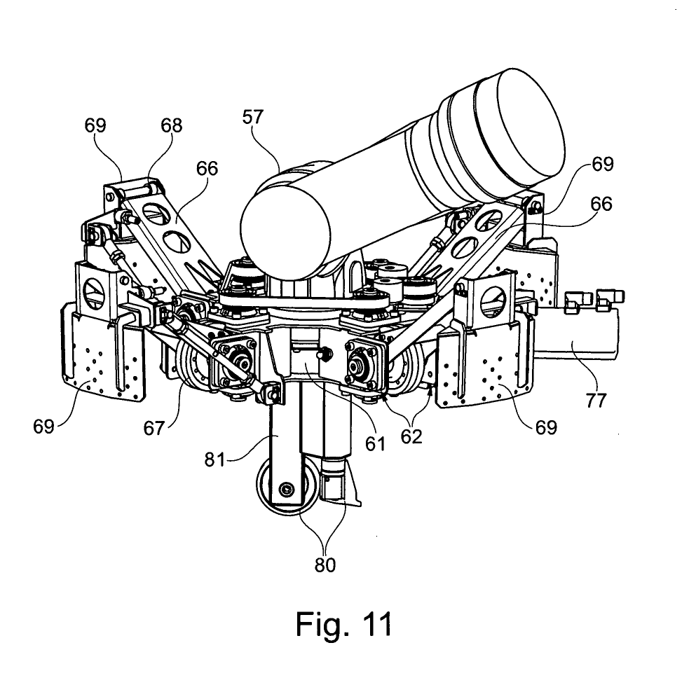

The disclosed configuration of the gripper 60 and of the drive of the gripper arms 66 means that the gripper arms 66 can pass through a large pivot angle of over 90°, and in particular, as shown in FIG. 11, can be moved sufficiently far upwards in the direction of the robot hand 57 that the holding plates of the gripper fingers 69 are at the level of the arms 62 of the base body 61.

On the underside of the base body, remote from the robot hand 57, mounting tools 80 required for mounting the second tire bead as disclosed above are fastened to columns 81, which extend in the direction of the central axis of the gripper 60. The columns 81 may be comparatively short and correspondingly highly rigid, since the gripper arms 66 and gripper fingers 69 can be moved a long way upwards out of the working region below the base body 61. The resulting high rigidity of the columns 81 makes precise guidance of the mounting tools 80 possible and reduces the risk of damage to the rim and to the tire bead during assembly. Further, the small distance at which the mounting tools 80 may be positioned from the robot hand 57 reduces the load of the drive of the robot hand 57 and of the articulated arm of the handling robot, improving the method and increasing the service life of the handling robot.

What is claimed is:

1. A method for mounting a pneumatic tire on a drop base rim of a vehicle wheel by using a gripper, which is arranged on a handling device and movable in multiple directions by said handling device, and mounting tools arranged on said gripper, comprising a first step, in which the pneumatic tire placed in a preparation position is gripped by said gripper on the tread, and brought up by said gripper and the handling device to the rim, which is held in a fixing device, and a first tire bead of the pneumatic tire, which faces the rim, is slipped over a flange of the rim by controlled movement of the pneumatic tire and said gripper, which holds the pneumatic tire, and subsequent to mounting of the first tire a second step, in which the gripper is released from the pneumatic tire, and the pneumatic tire is moved into a starting position for mounting the second tire bead by adjustment members, which are arranged on the fixing device, the mounting tools arranged on the gripper are brought into a working position on the rim held in the fixing device by moving the gripper, and the mounting tools are guided along on the rim flange by rotating the gripper about the axis of the rim in such a way, that the second tire bead is slipped over the rim flange by the mounting tools.

2. Device for mounting a pneumatic tire on a drop base rim of a vehicle wheel, comprising a handling device, having an articulated arm, which can be moved in three directions and which comprises at the free end thereof a gripper having at least two gripper arms, which can move radially relative to the central axis of the gripper, for gripping and holding pneumatic tires, and having actuating drives for rotating the gripper on the articulated arm about the central axis and about at least one further axis and for locking said arm in any desired angular positions of rotation, and a mounting station, which is arranged in the working region of the handling device and the gripper and comprises gripping means for releasably holding a rim and adjustment members for positioning the pneumatic tire relative to the rim, wherein mounting tools for mounting a tire bead to a rim are arranged on the gripper, and the gripper and optionally the articulated arm can be moved on a circular path by means of the actuating drives, in such a way that the mounting tools can be guided along on the flange of the rim.

3. Device according to claim 2, wherein the mounting tools are arranged on a gripper arm and in that the gripper arms can be moved into a closed position in which the free ends of the gripper arms abut against one another.

4. Device according to claim 2, wherein holding means are arranged at the free ends of the gripper arms, and engage with one another, preventing relative movement of the gripper arms, when the gripper arms are in the closed position.

5. Device according to claim 4, wherein each gripper arm comprises a holding plate, orientated parallel to the central axis of the gripper and comprising edges which extend in the direction of the central axis and are provided with projections and recesses, and in that the edges of the holding plates abut against one another when the gripper arms are in the closed position, the projections and recesses engaging with one another and preventing relative movement of the holding plates.

6. Device according to claim 2, wherein the gripper comprises a central base body on which the gripper arms are mounted, and in that the gripper arms are coupled by a synchronisation device which synchronises the radial movement thereof, each gripper arm having a parallel connecting rod, one end of each connecting rod being connected by hinges to the base body and the other end thereof being rotatably connected to a holding plate by a gripper finger in such a way that the gripper arm and the connecting rod form a parallel guide for the gripper finger and the holding plate.

7. Device according to claim 2, wherein the gripper arms and the tools for attaching a tire bead are arranged on a central base body of the gripper, the tools are connected to the base body in a bending-resistant manner, and the gripper arms can be moved into a spread position in which they are positioned outside the working region of the tools.

8. Device according to claim 2, wherein the gripper arms are each driven by a toothed wheel, which is arranged coaxial with the axis of rotation of the gripper arm and rotationally engaged with the gripper arm.

9. Device according to claim 8, wherein the toothed wheel is engaged with a worm wheel, which is rotatably mounted and supported on the base body and can be driven by a cylindrical gear which is rotationally engaged with the worm wheel.

10. Device according to claim 9, wherein the cylindrical gears of the drive of the gripper arms are engaged with a toothed belt, which is guided around the cylindrical gears and around a drive wheel which can be driven by a motor.

11. Device according to claim 10, wherein an angular gear, via which the motor is coupled to the drive wheel, is arranged on the base body.

12. Device according to claim 2, wherein the handling device comprises load sensors for detecting the loads occurring during tire mounting.

13. Device according to claim 2, wherein the handling device comprises a programmable control device.

14. Device according to claim 13, wherein the control device comprises a monitoring device which monitors the signals of the load sensors.
